(19) United States
(12) Patent Application Publication
(10) Pub. No.: US 2008/0137038 A1
(43) Pub. Date: Jun. 12, 2008

(54) System and mehtod for projecting images

(76) Inventor: Nathan B. Winstanley, Lenox, MA (US)

Correspondence Address: TOBIN, CARBERRY, O'MALLEY, RILEY, SELINGER, P.C., 43 BROAD STREET, PO BOX 58, NEW LONDON, CT, 06320, US

(21) Appl. No.: 11/985,819

(22) Filed: Nov. 16, 2007

Related U.S. Application Data
(60) Provisional application No. 60/873,597, filed on Dec. 8, 2006.

(51) Int. Cl. G03B 21/14

(52) U.S. Cl. 353/28; 353/121; 353/122

(57) ABSTRACT

A system for displaying images on a basketball goal is disclosed. The system comprises a basketball backboard comprising at least a portion of a laminated panel that appears frosted. An electrical source is electrically coupled to the laminated panel such that the electrical source is configured to transmit a voltage to the laminated panel to render it clear. A projector is configured to project an image onto the laminated panel when the laminated panel appears frosted. A controller is configured to transmit signals to the electrical source and the projector. The signals relay information to activate and deactivate the electrical source and the projector.

### PRIORITY CLAIM

This Application claims priority to U.S. Provisional Patent Application No. 60/873,597, entitled “Projection Backboard” filed on Dec. 8, 2006, the disclosure of which is incorporated herein in its entirety by reference.

### BACKGROUND

The present disclosure relates generally to a system and method for displaying information in sports arenas, and more particularly, to displaying information for spectators on basketball backboards, hockey rink safety walls, and other clear glass and/or plastic surfaces.

As spectator sports increase in popularity and attendance, there is an increasing need for available seating at sports venues and public arenas. However, in order to accommodate more seating within an arena or sports venue, seats are often placed in areas with somewhat obstructed views (e.g., behind a basketball backboard). In order to reduce obstructed views from behind basketball backboards, backboards have been made of glass or other clear, rigid materials.

In other sports arenas, such as indoor soccer or ice hockey arenas, safety barriers surround the playing area. In order to improve spectator views, this safety barrier includes a glass or clear plastic wall portion. The glass or plastic portion allows a spectator an unobstructed view of the game, while deflecting potentially hazardous objects.

Additionally, there are instances when spectators may prefer seats in close proximity to the players and the playing area. These spectators may prefer seats directly alongside a basketball court or up against the walls surrounding an ice hockey rink. While these seats may offer excellent views of the playing area, at times these seats do not provide a convenient view of the scoreboard and/or advertisements in the arena (i.e., the scoreboard or advertisements are generally located overhead or across the arena on a far wall). In order to provide more advertising, arenas often increase the number of displays in the hopes that the spectators will be able to view them.

Conventional wisdom for many arenas has been to utilize multiple scoreboards, display screens, and advertising placards throughout the arena. This allows all spectators to monitor the game progress while noting the advertisers. Unfortunately, this tactic for the arenas produces more obstructions for spectators to actually view the action on the field of play. Additionally, many seats in arenas may not be conveniently located to view any display overhead or across the arena, and the addition of scoreboards, displays, and advertisements can be superfluous. Likewise, there is an increased cost with the addition of overhead displays, which are often hung from the ceiling and require not only a great amount of anchoring and support, but also a good deal of engineering simply to install and operate.

What is needed in the art is a means of conveniently displaying information to customers without permanently obstructing views. More particularly, what is needed in the art is a means of providing information to spectators that takes advantage of the design of a sports arena, while at the same time not obstructing spectators' views of the arena.

### SUMMARY

The following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. Its sole purpose is to present some concepts of the present disclosure in a simplified form as a prelude to the more detailed description that is presented herein.

The disclosure is directed towards a system for displaying images on a basketball goal is disclosed. The system comprises a basketball backboard comprising at least a portion of a laminated panel that appears frosted. An electrical source is electrically coupled to the laminated panel such that the electrical source is configured to transmit a voltage to the laminated panel to render it clear. A projector is configured to project an image onto the laminated panel when the laminated panel appears frosted. A controller is configured to transmit signals to the electrical source and the projector. The signals relay information to activate and deactivate the electrical source and the projector.

The disclosure is also directed towards a system for displaying images in a sports arena. The system comprises a laminated panel physically coupled to a safety partition in the sports arena. The laminated panel appears frosted. An electrical source is coupled to the laminated panel and configured to transmit a voltage to the laminated panel to render it clear. A projector is configured to project at least one image onto the laminated panel that appears frosted. At least one controller is coupled to the electrical source and to the projector. The controller is configured to transmit signals to the electrical source and projector. The signals relay information to activate and deactivate the electrical source and the projector.

The disclosure is also directed towards a method for displaying images on a basketball backboard. The method comprises transmitting a signal from at least one controller to an electrical source. The signal relays information to activate the electrical source. The method also comprises supplying a voltage from the electrical source to a laminated panel appearing frosted. The voltage renders the laminated panel clear. The laminated panel is integral the basketball backboard. The method also comprises transmitting another signal from the at least one controller to the electrical source. The another signal relays information to deactivate a supply of the voltage. The method also comprises ceasing the supply of the voltage to the laminated panel to render it frosted. The method also comprises transmitting a signal from the at least one controller to a projector configured to display at least one image. The signal relays information to activate the projector. The method also comprises displaying the at least one image on the laminated panel when appearing frosted for a period of time. The method also comprises transmitting another signal from the at least one controller to the projector. The another signal relays information to deactivate the projector. The method also comprises ceasing the displaying of the at least one image from the projector.

The disclosure is also directed towards a method for displaying images in a sports arena. The method comprises transmitting a signal from a controller to an electrical source. The signal relays information to activate the electrical source. The method also comprises supplying a voltage from the electrical source to a laminated panel appearing frosted. The voltage renders the laminated panel clear. The laminated panel is physically coupled to a safety partition in the sports arena. The method also comprises transmitting another signal from the controller to the electrical source. The another signal relays information to deactivate a supply of the voltage. The method also comprises ceasing the supply of the voltage to the laminated panel rendering it frosted. The method also comprises transmitting a signal from the controller to a projector configured to display an image. The signal relays information to activate the projector. The method also comprises displaying the image on the laminated panel when appearing frosted for a period of time. The method also comprises transmitting another signal from the controller to the projector. The another signal relays information to deactivate the projector. The method also comprises ceasing the displaying of the image from the projector.

### BRIEF DESCRIPTION OF THE FIGURES

Referring now to the figures, wherein like elements are numbered alike:

FIG. 1 is a side view of an exemplary embodiment of the system for projecting images coupled to a basketball goal;

FIG. 2 is a front view of the system for projecting images coupled to a basketball goal;

FIG. 3 is another front view of the system for projecting images coupled to a basketball goal;

FIG. 4 is a perspective view of another embodiment of the system for projecting images disposed within a sports arena;

FIG. 5 is a perspective view of another embodiment of the system for projecting images disposed within a sports arena for projecting images to a skybox area;

FIG. 6 is a perspective view of an exemplary embodiment of the laminated panel; and

FIG. 7 is a block diagram of the method of using the system for projecting images.

### DETAILED DESCRIPTION

Persons of ordinary skill in the art will realize that the following disclosure is illustrative only and not in any way limiting. Other embodiments of the disclosure will readily suggest themselves to such skilled persons having the benefit of this disclosure.

In order to provide more versatile informational, entertainment and advertising space in a sports arena without obstructing the views of the spectators, the present disclosure provides an easy solution. The present disclosure provides a system and method of projecting images onto a frosted surface, which can be changed from clear to frosted, that is conveniently located in a sports arena. For example, some convenient locations can include a basketball backboard, hockey or skating rink safety barriers, indoor soccer safety barriers, and any sports arena safety barrier. The images that can be projected can include advertisements, game scores, words, phrases, numbers, pictures, characters, and combinations thereof. The possibilities of images to project and the locations to project upon are endless, providing the ability to transform clear surfaces into active display surfaces.

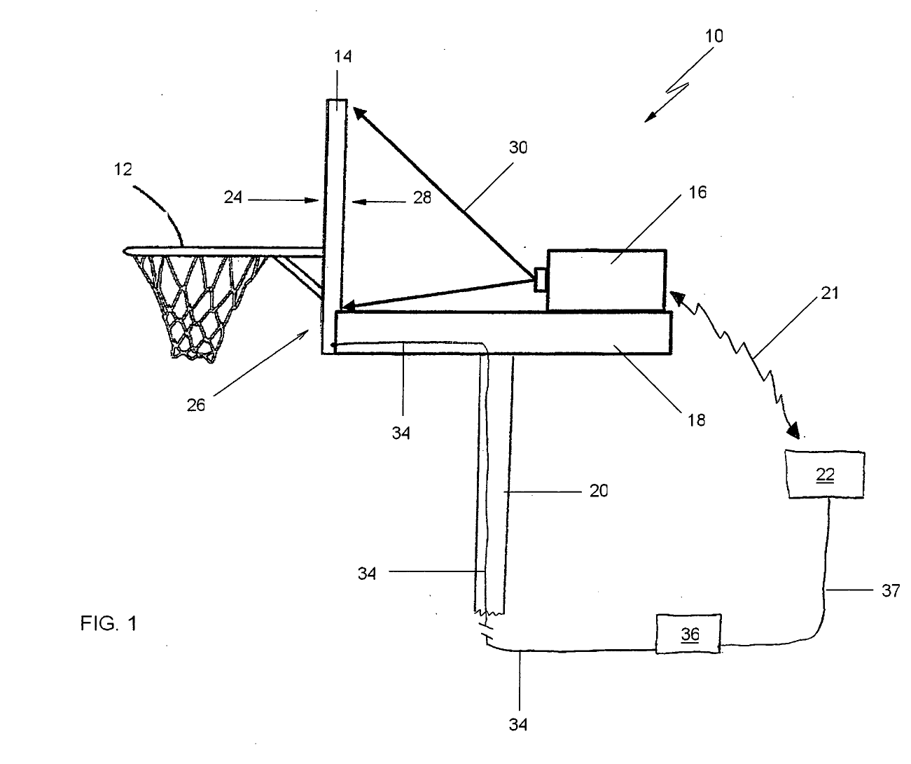

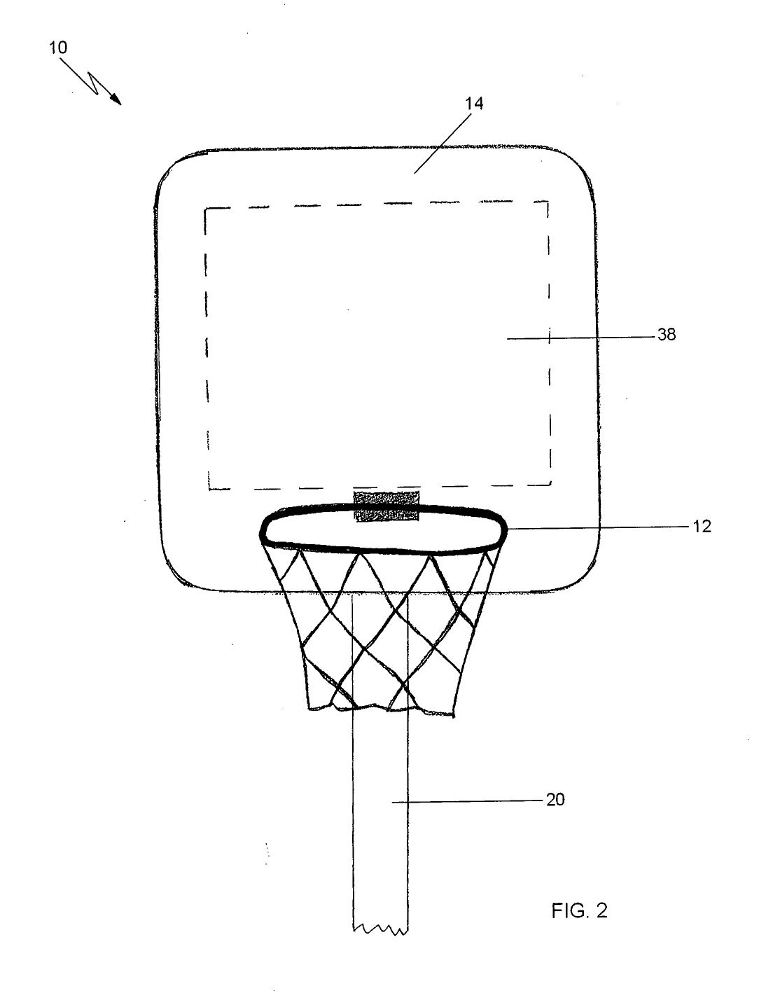

Referring to FIGS. 1 and 2, a side view of an exemplary embodiment of the system for projecting images onto a frosted surface for a basketball goal is illustrated in FIG. 1 and a front view of an exemplary embodiment of the system for projecting images onto a frosted surface for a basketball goal is illustrated in FIG. 2.

FIG. 1 illustrates a basketball goal 10 having a basketball rim with a net 12, a backboard 14, a projector (or displayer) 16, and a base 18 coupled to a support system 20. The support system 20 can be either a stationary or portable system. Additionally, the backboard 14, including the base 18, may be configured to adjust to the appropriate height as desired. The backboard 14 comprises a specialized material that will be discussed further herein. The projector 16 is illustrated (via arrow 21) as being wirelessly coupled to a controller 22, further details of the controller 22 will be discussed herein. Electrical wiring 34 is coupled to the backboard 14 and to an electrical source 36. The electrical source 36 is also physically coupled to the controller 22 via coupler 37, which will be discussed further herein.

In this particular embodiment, the basketball rim 12 can be coupled to the front 24 bottom portion 26 of the backboard 14 or to another appropriate location on the basketball goal 10. The rear 28 bottom portion 26 of the backboard 14 is coupled to the base 18, such that the backboard 14 extends vertically from the base 18, as illustrated. A projector 16 can be mounted to the base 18 utilizing conventional mounting methods including, but not limited to, strapping, welding or bolting. Referring to FIG. 2, the projector 16 is configured to project (as illustrated with arrows 30 and 32) an image 38 (i.e., game scores, pictures, advertisements, names, words, messages, statistics, questions, trivia, and the like) onto the rear 28 of the specialized material of the backboard 14. The projection of the image 38 will be discussed further herein. The backboard 14 may be completely comprising the specialized material or comprising only a portion of the specialized material.

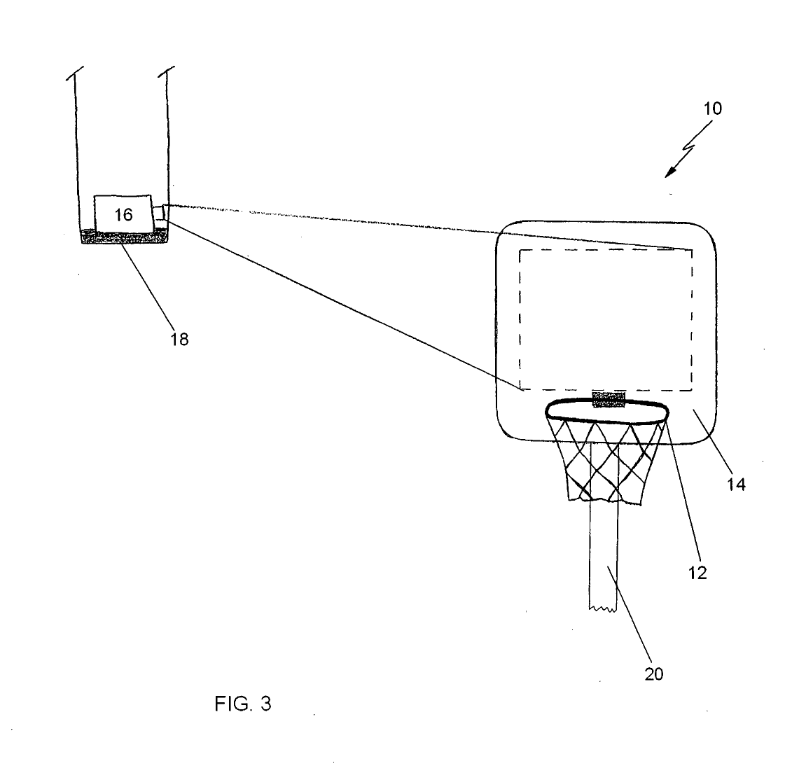

FIG. 3 illustrates another embodiment for using a projector 16 to project an image 38 onto a specialized material utilized in a basketball backboard 14. A projector 16 can be positioned at a location remote from the basketball goal 10. The projector 16 can be configured to project an image 38 onto the backboard 14 from the rear 28 as illustrated in FIG. 1 or from the front 24 as illustrated in FIG. 3. The projectors 16 can each be positioned on a base 18 above the spectators so as to not obstruct any views, or in the alternative, the projectors 16 may be positioned in a room (not shown) or attached to a wall (not shown). As indicated above, the backboard 14 may be completely comprising the specialized material or comprising only a portion of the specialized material.

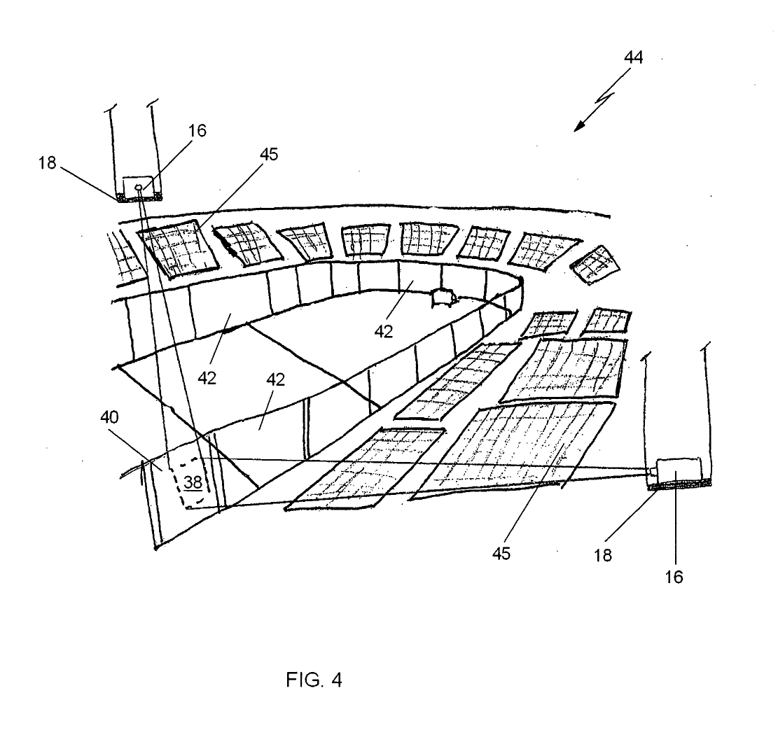

FIG. 4 illustrates the safety partition (or safety glass or safety barrier) 40 having the specialized material which, when coupled to other conventional safety partitions 42, surrounds a sports arena (e.g., a hockey rink, a skating rink, an indoor soccer field, and the like) 44. Each conventional safety partition 42 can be comprised of conventional clear safety partition material. It is contemplated that a conventional safety partition 42 can be completely removed and replaced with a specific section of the specialized material safety partition 40 comprising a specialized material that will be discussed further herein. It is also contemplated that the specialized material safety partition 40 can be merely a portion of (or integral with) the conventional safety partition 42.

In this embodiment, several projectors 16 may be utilized to project images 38 in several different desired locations throughout the arena 44. The projector 16 can be configured to project any image 38 onto the specialized material safety partition 40 from the rear or from the front, as illustrated in FIG. 4. In this embodiment, it is contemplated that the projectors 16 are generally positioned on bases 18 above the spectators 45 so as to not obstruct any views, or in the alternative, the projectors 16 may be positioned in a room (not shown) or attached to a wall (not shown). Although only one specialized material safety partition 40 is illustrated, it is contemplated to have several specialized material safety partitions 40 positioned throughout the arena 44.

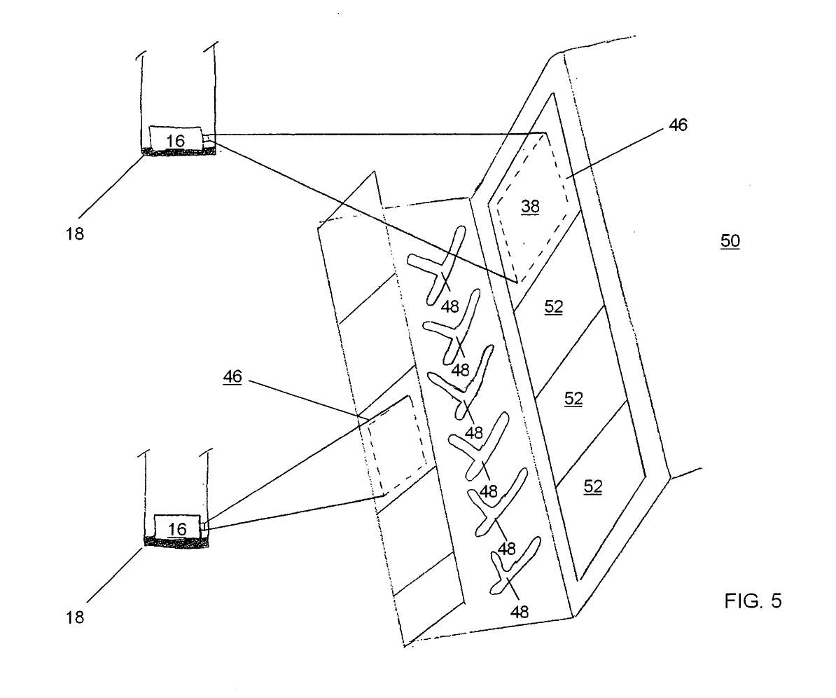

FIG. 5 illustrates yet another embodiment for using a projector 16 to project an image 38 onto a specialized material 46. A projector 16 can be positioned in a sports arena (e.g. a basketball arena, a football stadium, a baseball field, a hockey rink, a skating rink, an indoor soccer field, and the like) at a remote location from the specialized material portion 46. In this embodiment, the specialized material 46 can be a portion of the conventional safety partitions 42 protecting exterior seats 48 of a skybox (or luxury box) 50 or a portion of the entire skybox (or luxury box) 50. The projector 16 can be configured to project an image 38 onto the specialized material section 46 of the conventional safety partitions 42, as indicated in FIG. 5. It is also contemplated that a skybox 50 may have windows 52 completely comprising the specialized material sections 46 or only a portion of the specialized material section 46. The projector 16 can project the images 38 from the rear (in which the projector would be located within the skybox 50) or from the front (in which the projector would be located within the arena, as illustrated in FIG. 5).

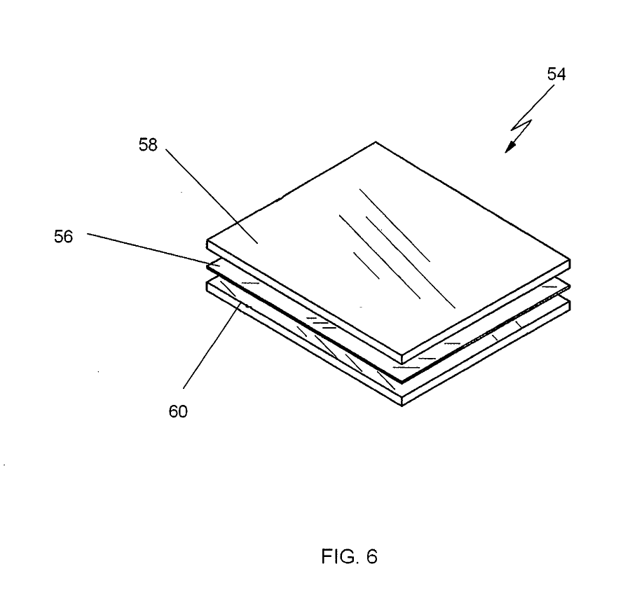

Referring now to FIG. 6, a laminated panel 54 is utilized as the specialized material 46 for the backboard 14, the specialized material safety partitions 40 and/or the windows 52. The laminated panel can comprise as a substrate either a glass or plastic material. A preferred laminated glass panel has been developed by The LTI Group. For ease in understanding, the example of the specialized material will be described as being a laminated glass panel. The laminated panel 54 comprises a sheet of liquid crystal material 56 coupled between two sheets of glass 58, 60. In the alternative, the liquid crystal material can be applied directly to the desired substrate (i.e., glass and/or plastic). The liquid crystal sheet 56 comprises randomly aligned liquid crystal molecules that disperse light (i.e., the laminated panel 54 appears frosted). When appearing frosted, the laminated panel 54 is not opaque and can allow light to pass through allowing objects to enable objects to appear on the opposite side of projection. The liquid crystal sheet 56 is coupled to a voltage source (i.e., electrical source 36) and when voltage is applied to the liquid crystal sheet 56, the liquid crystal molecules arrange themselves in a specific direction that permits parallel light to pass through the laminated panel 54, thereby appearing clear.

For ease in understanding, the following example is presented. For a basketball arena, backboard 14 of FIG. 2 comprises a laminated panel 54. During a basketball game, a voltage can be applied to the backboard 14 to render the backboard 14 virtually clear so as to not obstruct the spectators' views. At a point in the game (e.g., time outs, half time, breaks, and the like) or throughout the game, the voltage can cease causing the backboard 14 to appear frosted (or “frosted”). At this point, the projector 16 can project an image 38 onto the backboard 14. As indicated above, the projector 16 may project images on the entire surface of the backboard 14, or onto only a portion of the backboard 14.

As indicated in FIG. 1, the projector 16 can project images 38 onto the rear 28 of the backboard 14 (i.e., the laminated panel 54) such that the images 38 appear properly oriented on the front 24 of the backboard 14 when in the frosted mode. Any conventional projector 16 can be operated in a mirror mode in order to achieve proper orientation of the images. In alternative embodiments described above, the projector(s) 16 may be mounted in front of the laminated panel(s) 54 and project images directly onto the front of laminated panel(s) 54, such that the images 38 are properly oriented for the spectators viewing the front 24 of the backboard 14 A projector 16 can directly display the images 38 or it can utilize mirrors or other optics, known in the art, to configure the images produced by the projector 16 and display the images 38 onto the laminated glass portion 54.

The laminated panel 54 is coupled via conventional wiring 34 to an electrical circuit (or source) 36, as illustrated in FIG. 1. Upon activating the electrical source 36, a voltage is transferred through the wiring 34 to the laminated panel 54. The amount of voltage applied to the laminated panel 54 is low (i.e., about 0.1 watts per square foot to 0.5 watts per square foot, with about 0.30 watts per square foot preferred). The electrical source 36 can be manually controlled or remotely operated. It can be either physically coupled via coupler 37 or remotely (i.e., wirelessly) coupled (not shown) to the controller 22 for controlling the transmission of electricity to the laminated panel 54.

The laminated panel 54 is coupled to a controller 22 that can control the activation of the voltage to the laminated panel 54. Although the controller 22 is illustrated as being able to operate both the projector 16 and the laminated panel 54, it is contemplated that two or more controllers 22 can be utilized. The controller 22 can be a computer with appropriate programs, a simple switch, a remote control, or other appropriate controller that is configured to send (and possibly receive) signals to activate and deactivate the projector 16 and/or the laminated panel 54.

The projector 16 utilized can be any conventional projector that can be project images. The projector 16 can be manually controlled or remotely operated. It can be either physically (not shown) or remotely (i.e., wirelessly via arrow 21) coupled to a controller 22 for controlling the transmission of instructions to and from the projector 16. The, projector 16 can be operated to activate either manually or automatically.

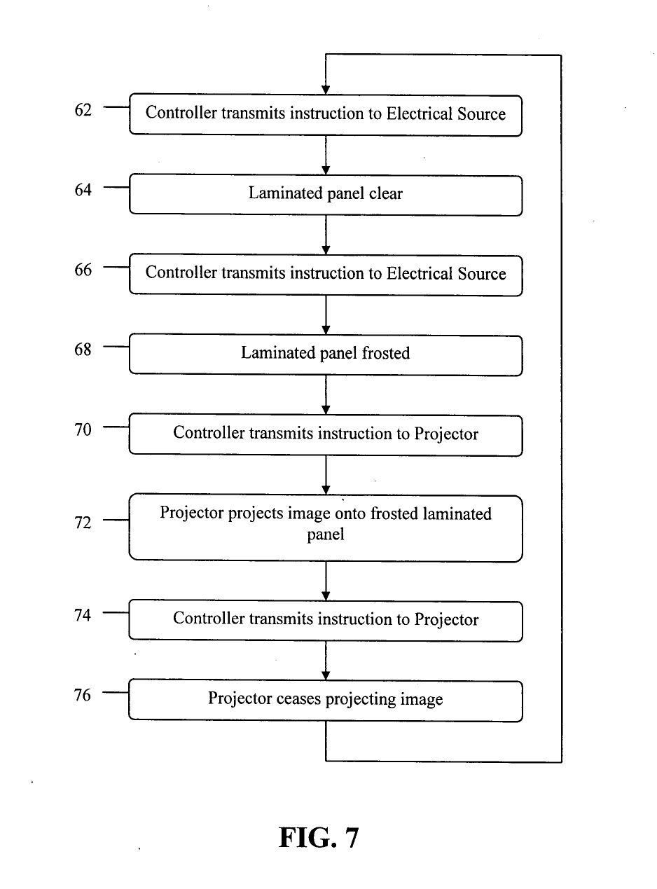

Referring now to FIG. 7, a block diagram illustrating the method of using the system is presented. In use, a controller can transmit an instruction (or signal) to the electrical source (box 62) to supply a voltage to the laminated panel to render the panel virtually clear (box 64). At a specific time, either manually or automatically, the controller can transmit a signal to the electrical source (box 66) to stop the voltage to the laminated panel rendering the laminated panel frosted (box 68). The controller can then transmit instructions to the projector (box 70) to project an image onto the laminated panel for a period of time (i.e., a viewing period) (box 72). The images projected can be any type of image from simple images or words to images in motion. It is also contemplated to have the images change throughout the viewing period to maximize advertising viewing. At the end of the viewing period, the controller can transmit instructions to the projector (box 74) to stop projecting images (box 76) and transmit instructions to the electrical source (box 62) to resume the voltage to the laminated panel, thereby reverting to clear mode.

The present disclosure provides many advantages. It allows for more advertising space without obstructing any views. The system is easily installed, virtually maintenance free and relatively inexpensive. The method of activating the system is easily maintained and requires little to no maintenance. The system of displaying images and information can be changed easily without the use of manual labor. It is a time saving and cost saving system. This system can be installed in a variety of venues, including but not limited to, basketball arenas, hockey or skating rinks, indoor soccer field, football stadiums, soccer stadiums, baseball parks, and the like. The images that can be projected can include advertisements, game scores, words, phrases, numbers, pictures, characters, and combinations thereof. The possibilities of images to project and the locations to project upon are endless.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings without departing from the essential scope thereof. Therefore, it is intended that the disclosure not be limited to the particular embodiment disclosed as the best mode contemplated for carrying out this disclosure.

What is claimed is:

1. A system for displaying images on a basketball goal comprising:
a basketball backboard comprising at least a portion of a laminated panel, said laminated panel appears frosted;
an electrical source electrically coupled to said laminated panel, said electrical source configured to transmit a voltage to said laminated panel to render said laminated panel clear;
a projector configured to project at least one image onto said laminated panel when said laminated panel appears frosted; and
at least one controller configured to transmit signals to said electrical source and to said projector, wherein said signals relay information to activate and deactivate said electrical source and said projector.

2. The system of claim 1, wherein said laminated panel comprises a liquid crystal material disposed between at least two substrates; and
wherein said at least two substrates comprise a material selected from a group comprising glass and plastic.

3. The system of claim 1, wherein said controller is at least one of a computer and a remote control.

4. The system of claim 1, wherein said controller is at least one of physically coupled to said electrical source, physically coupled to said projector, wirelessly coupled to said electrical source, and wirelessly coupled to said projector.

5. The system of claim 1, wherein said projector is disposed on a rear side of said laminated panel.

6. The system of claim 1, wherein said projector is disposed on a front side of said laminated panel.

7. The system of claim 1, wherein said projector is disposed on a base physically coupled to said basketball backboard.

8. A system for displaying images in a sports arena comprising:
a laminated panel physically coupled to a safety partition in the sports arena, said laminated panel appearing frosted;
an electrical source coupled to said laminated panel, said electrical source configured to transmit a voltage to said laminated panel to render said laminated panel clear;
a projector configured to project at least one image onto said laminated panel appearing frosted; and
at least one controller coupled to said electrical source and to said projector, said at least one controller configured to transmit signals to said electrical source and to said projector, wherein said signals relay information to activate and deactivate said electrical source and said projector.

9. The system of claim 8, wherein said laminated panel comprises a liquid crystal material disposed between at least two substrates; and
wherein said at least two substrates comprise a material selected from a group comprising glass and plastic.

10. The system of claim 8, wherein said laminated panel is integral with said safety partition.

11. The system of claim 8, wherein the sports arena is selected from the group comprising basketball arenas, hockey rinks, skating rinks, indoor soccer fields, football stadiums, soccer stadiums, and baseball stadiums.

12. The system of claim 8, wherein said controller is at least one of a computer and a remote control.

13. The system of claim 8, wherein said controller is at least one of physically coupled to said electrical source, physically coupled to said projector, wirelessly coupled to said electrical source, and wirelessly coupled to said projector.

14. The system of claim 8, wherein said projector is disposed on a rear side of said laminated panel.

15. The system of claim 8, wherein said projector is disposed on a front side of said laminated panel.

16. A method for displaying images on a basketball backboard comprising:
transmitting a signal from at least one controller to an electrical source, said signal relays information to activate said electrical source;
supplying a voltage from said electrical source to a laminated panel appearing frosted, said voltage renders said laminated panel clear, wherein said laminated panel is integral the basketball backboard;
transmitting another signal from said at least one controller to said electrical source, said another signal relaying information to deactivate a supply of said voltage;
ceasing said supply of said voltage to said laminated panel rendering said laminated panel frosted;
transmitting a signal from said at least one controller to a projector configured to display at least one image, said signal relays information to activate said projector;
displaying said at least one image on said laminated panel when appearing frosted for a period of time;
transmitting another signal from said at least one controller to said projector, said another signal relaying information to deactivate said projector; and
ceasing said displaying of said at least one image from said projector.

17. The method of claim 16, wherein said laminated panel comprises a liquid crystal material disposed between at least two substrates; and
wherein said at least two substrates comprise a material selected from a group comprising glass and plastic.

18. The method of claim 16, wherein said controller is at least one of a computer and a remote control.

19. The method of claim 16, wherein said projector is disposed on a rear side of said laminated panel.

20. A method for displaying images in a sports arena comprising:
transmitting a signal from at least one controller to an electrical source, said signal relays information to activate said electrical source;
supplying a voltage from said electrical source to a laminated panel appearing frosted, said voltage renders said laminated panel clear, wherein said laminated panel is physically coupled to a safety partition in the sports arena;
transmitting another signal from said at least one controller to said electrical source, said another signal relaying information to deactivate a supply of said voltage;
ceasing said supply of said voltage to said laminated panel rendering said laminated panel frosted;
transmitting a signal from said at least one controller to a projector configured to display at least one image, said signal relays information to activate said projector;
displaying said at least one image on said laminated panel when appearing frosted for a period of time;
transmitting another signal from said at least one controller to said projector, said another signal relaying information to deactivate said projector; and
ceasing said displaying of said at least one image from said projector.

21. The method of claim 20, wherein said laminated panel comprises a liquid crystal material disposed between at least two substrates; and
wherein said at least two substrates comprise a material selected from a group comprising glass and plastic.

22. The method of claim 20, wherein said laminated panel is integral with said safety partition.

23. The method of claim 20, wherein the sports arena is selected from the group comprising basketball arenas, hockey rinks, skating rinks, indoor soccer fields, football stadiums, soccer stadiums, and baseball stadiums.

24. The method of claim 20, wherein said controller is at least one of a computer and a remote control.
